(19) United States
(12) Patent Application Publication
(10) Pub. No.: US 2024/0247985 A1
(43) Pub. Date: Jul. 25, 2024

(54) METHOD FOR DETECTING THE CONVECTIVE HEAT TRANSFER COEFFICIENT AND THE THICKNESS OF AN INTERFACE

(71) Applicant: FRAUNHOFER-GESELLSCHAFT ZUR FÖRDERUNG DER ANGEWANDTEN FORSCHUNG E.V., MUNICH (DE)

(72) Inventors: ERHARD MAYER, HOLZKIRCHEN (DE); MICHAEL VISSER, VALLEY (DE); JOHN CULLEN SIMPSON, VALLEY (DE)

(73) Assignee: FRAUNHOFER-GESELLSCHAFT ZUR FÖRDERUNG DER ANGEWANDTEN FORSCHUNG E.V., MUNICH (DE)

(21) Appl. No.: 18/627,518

(22) Filed: Apr. 5, 2024

Related U.S. Application Data
(63) Continuation-in-part of application No. PCT/EP2022/077935, filed on Oct. 7, 2022.

(30) Foreign Application Priority Data
Oct. 8, 2021 (DE) 102021211392.3

(51) Int. Cl. G01K 17/20; G01B 21/08

(52) U.S. Cl. CPC G01K 17/20; G01B 21/085

(57) ABSTRACT

An interfacial sensor and method for determining the thickness of an interface above a surface of a body around which flow occurs. The sensor has a first device for determining a first temperature, a second device for determining a second temperature and a third device for determining a third temperature. Each device is arranged at a predefinable distance (XI, X2, X3) from the surface of the body) around which flow occurs. At least the second device for determining the second temperature and the third device for determining the third temperature includes at least one wire which extends from the surface into a half-space adjoining the surface and which has a diameter of approximately 300 μm or less. Such a sensor may find use in a wind turbine, a vehicle, an aircraft, a room climate measuring device or a ship.

### RELATED APPLICATIONS

This is Bypass Continuation-in-Part of PCT/EP2022/077935 filed 7 Oct. 2022, and published as WO 2023/057625A1. Priority is claimed to DE 10 2021 211 392.3 filed 8 Oct. 2021. The contents of the aforementioned applications are incorporated by reference in their entirety.

### FIELD OF THE INVENTION

The invention relates to a system and method for detecting the convective heat transfer coefficient on a surface of a body around which flow occurs and/or which is heated.

### BACKGROUND

An apparatus for determining the convective heat transfer coefficient on a heated surface is known from DE 10 2016 107 212 A1. This known apparatus measures the temperature difference between the surface temperature of the convection surface and the ambient temperature as well as a further temperature difference between a temperature in the vicinity of the convection surface within the interface and the ambient temperature. This well-known sensor is based on the insight that the temperature profile within the interface includes an exponential curve, with the convective heat transfer coefficient as a constant. By determining three supporting points, it is thus possible to determine the exponential curve and therefrom the convective heat transfer coefficient. This known apparatus is also referred to below as a CHM sensor.

Alternatively, the exponential drop in the air temperature above a convection surface can be determined optically by means of a laser differential interferometer. A measurement setup of this type renders possible an accurate detection of the temperature profile and thus of the convective heat transfer coefficient h_{c}. However, the amount of technical equipment is very great so that a measurement of this type is not suitable for routine measurements.

It has been shown that the measured values of the convective heat transfer coefficient that are determined optically by means of laser differential interferometry differ from the values which were measured with the design of thermocouples in the interface that is known from DE 10 2016 107 212 A1. On the basis of the prior art, the object of the invention is therefore to provide a method for determining the convective heat transfer coefficient, which requires less technical equipment than the known optical measurement and nevertheless provides similarly accurate measurement results.

### SUMMARY

A method for detecting a convective heat transfer coefficient h_{c} on a surface of a body around which flow occurs and/or which is heated, in which a first temperature, a second temperature and a third temperature are each measured at a predeterminable distance from the surface of the body around which flow occurs, at least a first device for determining a temperature and a second device for determining a temperature and a third device for determining a temperature being used to measure the temperatures. The invention also relates to a method for detecting the thickness of an interface above a surface of a body around which flow occurs and/or which is heated, in which three temperatures are each measured at a predeterminable distance from the surface of the body around which flow occurs.

According to the invention, this object is achieved by one or more of the methods claimed below.

According to the invention, it is proposed to measure at least three temperatures on a surface of a body around which flow occurs and/or which is heated in order to detect the convective heat transfer coefficient h_{c}. In order to detect the temperatures, at least a first device for detecting a temperature, a second device for detecting a temperature and a third device for detecting a temperature are available, which are each arranged at a predeterminable and in each case different distance from the surface of the body around which flow occurs. In some embodiments of the invention, the at least three devices for detecting the temperatures can be resistance thermometers and/or thermocouples. For the purposes of the present description, the distance from the surface of the body around which flow occurs is defined as the length of the normal vector between the respective device for determining the temperature and the surface.

In some embodiments of the invention, the first device for detecting the temperature is arranged directly on the surface of the body around which flow occurs and/or which is heated, and the third device for detecting a temperature is arranged at a greater distance from the surface so that it comprises the ambient temperature. The second device for determining a temperature is located within the interface, for example at a distance of between about 1 mm and about 3 mm.

According to the invention, it was realized that the heat flowing off via the lead wires and/or the mechanical fastening apparatus of the devices for determining the temperatures leads to a falsification of the measured values. According to the prior art, this heat flow has not been taken into account to date so that the convective heat transfer coefficient hc was determined from the thermal conductivity λ_{L} of the flowing medium, the distance X2 of the second device for determining the temperature and the three measured temperatures Tₒ, Tₓ and T_{L} from the following formula, which assumes an undisturbed exponential curve of the temperature within the interface:

$${h}_{C} = \frac{{λ}_{L} \cdot [ ln ( {T}_{O} - {T}_{L} ) - ln ( {T}_{x} - {T}_{L} ) ]}{X 2}$$

According to the invention, however, it was realized that due to the heat conduction via the individual components of the devices for determining the temperatures, the temperature Tₓ at the point X2 assumes a different value which deviates from the undisturbed exponential temperature curve. According to the invention, it was therefore realized that the convective heat transfer coefficient h_{c} should be correctly determined from the measured temperatures, the distance X2 of the second device for determining a temperature and the heat conduction coefficient λ_{M} of the apparatus used according to the invention as follows:

$${h}_{C} = \frac{{λ}_{M} \cdot [ ( {T}_{O} - {T}_{L} ) - ( {T}_{x} - {T}_{L} )}{X 2 \cdot ( {T}_{x} - {T}_{L} )}$$

The convective heat transfer coefficient h_{c} determined in this way substantially corresponds to the value determined by means of the laser differential interferometer, the convective heat transfer coefficient h_{c} being obtainable according to the invention with considerably less technical equipment. According to the invention, it is thus proposed to use the known apparatus containing only three devices for determining a temperature in order to detect the convective heat transfer coefficient and to achieve a significantly improved accuracy by a modified evaluation of the detected measured values.

In the same way, it is also possible in some embodiments of the invention to determine the thickness d of the interface above a surface of a body around which flow occurs and/or which is heated. The thickness d of the interface here denotes the distance X=d above the surface around which flow occurs, at which the maximum temperature difference between the surface and the environment has dropped to e⁻¹, i.e., about 36.788%, where e denotes Euler's number. Since the convective heat transfer coefficient h_{c} can be calculated from the heat conduction coefficient λ_{L} of the flowing medium and the interface thickness d as h_{c}=λ_{L}·d⁻¹, the thickness d of the interface is obtained from the measured temperatures Tₒ, Tₓ and T_{L}, the distance X2 of the second device for determining a temperature above the surface and the heat conduction coefficients λ_{L} of the flowing medium and λ_{M} of the sensor arrangement as:

$$d = \frac{{λ}_{L} \cdot X 2 \cdot ( {T}_{x} - {T}_{L} )}{{λ}_{M} \cdot [ ( {T}_{O} - {T}_{L} ) - ( {T}_{x} - {T}_{L} ) ]}$$

In some embodiments of the invention, the distance X3 at which the third temperature T_{L} is measured can be between about 9 mm and about 20 mm. In other embodiments of the invention, the distance X3 can be between about 10 mm and about 14 mm. In yet other embodiments of the invention, the distance X3 can be selected to be between about 11 mm and about 16 mm. This allows the third device for determining a temperature to be used to reliably determine the ambient temperature which is largely unaffected by the temperature of the surface.

In some embodiments of the invention, the first device for determining a temperature, the second device for determining a temperature and the third device for determining a temperature can each be formed by thermocouples, a first thermoelectric voltage U₁ being measured between the first and the third device for determining a temperature and a second thermoelectric voltage U₂ being measured between the second and the third device for determining a temperature. Since it is proposed according to the invention that, in order to determine the interface thickness d or the convective heat transfer coefficient h_{c}, only the temperature differences of the first and third or the second and third devices for determining a temperature be correlated, these temperature differences can thus be represented directly by the measured thermoelectric voltages. This facilitates the evaluation of the measurement so that an electrical signal representing the convective heat transfer coefficient can be generated directly with little technical equipment, for example an analog computing circuit. An analog computing circuit of this type can be realized with operational amplifiers, for example.

In some embodiments of the invention, the parameter

$$Λ = \frac{{λ}_{M}}{X 2}$$

can be determined by a calibration measurement. A calibration measurement takes into account the fact that the temperature Tₓ measured by the second device for determining a temperature is influenced by both the flowing medium as well as lead wires and optional mechanical fastening apparatuses of the sensor. This influence can either be determined mathematically by a computer simulation of the heat flows or, in a particularly simple way, by a calibration measurement for each sensor or each sensor type.

In some embodiments of the invention, the calibration measurement can be carried out by means of laser differential interferometry. Since laser differential interferometry provides a value measured without any contact, it can thus be used to determine the actual temperature Tₓ of the undisturbed interface. By comparing the measured value obtained in this way with the measured value of the second device for determining a temperature, the sensor according to the invention can be calibrated in a simple manner.

### BRIEF DESCRIPTION OF THE DRAWINGS

The invention shall be explained in more detail below on the basis of drawings and an exemplary embodiment. In these drawings:

FIG. 1 shows a schematic representation of a known CHM sensor.

FIG. 2 shows an equivalent circuit diagram of the CHM sensor to illustrate the heat flows.

FIG. 3 shows a comparison of the convective heat transfer coefficient versus the flow velocity with the evaluation of the measurement signals according to the invention and the known evaluation of the measurement signals.

FIG. 4 shows the measured values of the second device for detecting a temperature against the distance X2 thereof from the surface for different convective heat transfer coefficients in the case of an evaluation of the measured values according to the invention and according to the prior art.

FIG. 5 shows the measured value of the second device for detecting a temperature at a constant heat transfer coefficient for different calibration values λ.

### DETAILED DESCRIPTION

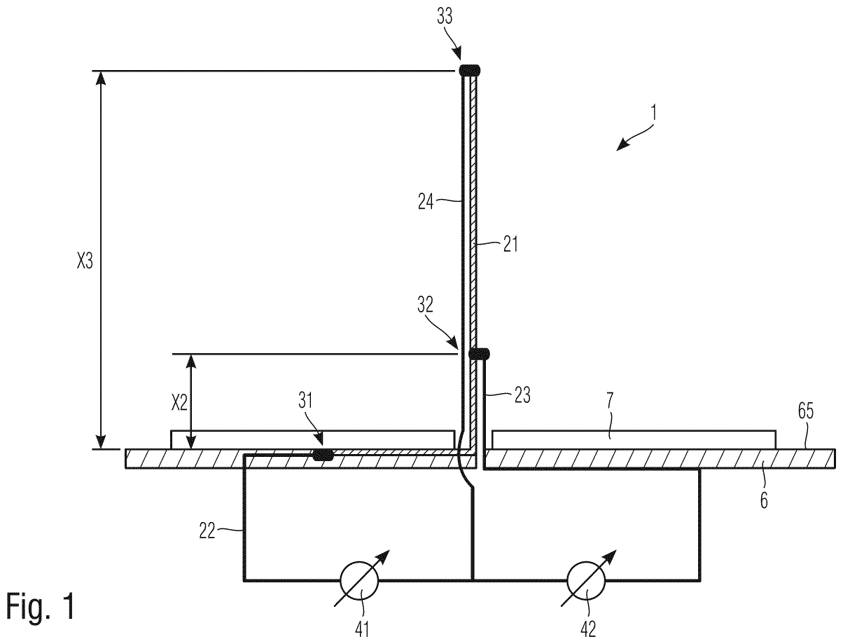

FIG. 1 shows a cross-section through a body 6 around which flow occurs and which has a surface 65. The body 6 can, for example, be part of a vehicle or aircraft or a ship. In other embodiments of the invention, the body 6 can be part of a wind turbine. In yet other embodiments of the invention, the body 6 can be part of a room climate measuring device which determines the convective heat transfer coefficient and/or the exchange of radiant heat with the environment. During the operation of the interface sensor 1, a forced flow or a convective flow flows around the body 6 so that a flow is formed in the half-space of the body 6 that is adjacent to the surface 65. The flow can run at least partially parallel to the body 6 or the surface 65. According to the invention, an interface sensor or CHM sensor 1 is used to detect the thickness of the interface and/or the convective heat transfer coefficient h_{c} above the surface 65.

The interface sensor 1 is designed to detect three temperatures or two temperature differences. For this purpose, the interface sensor has a first device for detecting a first temperature 31, which is arranged at a first distance X1 from the surface 65. In the illustrated exemplary embodiment, the first device 31 for detecting a first temperature is located directly on the surface 65. The distance X1 is therefore 0 mm.

Furthermore, the interface sensor 1 has a second device 32 for detecting a second temperature, which is arranged at a distance X2 above the surface 65. The distance X2 can be between 1 mm and about 3 mm, for example. The distance X2 is selected in such a way that the second device 32 for detecting a second temperature is located within the interface forming above the surface 65.

Finally, the interface sensor 1 has a third device 33 for determining a third temperature, which is arranged at a distance X3 above the surface 65. The distance X3 can, for example, be between about 9 mm and about 20 mm or between about 10 mm and about 14 mm or between 11 mm and about 16 mm. The distance X3 is selected in such a way that the third device for determining a third temperature detects the ambient temperature of the medium flowing above the surface 65 outside the interface. Thus, the distance X3 above the surface 65 can be selected on the basis of the expected flow velocity in such a way that a longer distance is selected when the flow velocity is low and a shorter distance is selected when the flow velocity is high. Thus, from the foregoing, X1<X2<X3.

In the illustrated exemplary embodiment, the first, second and third devices 31, 32 and 33 for determining temperatures are designed as thermocouples. For this purpose, the interface sensor 1 has a first wire 21, which consists of a first material. One end of the first wire 21 is connected to one end of a second wire 22. The second wire 22 is made of a second material so that a thermoelectric voltage can be formed at the contact point, which voltage represents a measure of the first temperature Tₒ of the surface 65.

The first wire 21 also has a second end which is arranged at a distance X3 from the surface 65. A third contact point with a fourth wire 24 is formed at this end. This contact point forms the third device 33 for determining the third temperature T_{L}. Similarly, a further contact point with a third wire 23 is located along the longitudinal extension of the first wire 21. This contact point forms the second device 32 for determining the second temperature Tₓ.

In some embodiments of the invention, two thermoelectric voltages can thus be determined. A first thermoelectric voltage is determined by means of a first measuring device 41 between the second wire 22 and the fourth wire 24, and a second thermoelectric voltage is determined by means of a second measuring device 42 between the fourth wire 24 and the third wire 23. The first thermoelectric voltage is thus a measure of the first temperature difference Tₒ−T_{L}. The second thermoelectric voltage is a measure of the second temperature difference Tₓ− T_{L}.

The interface sensor 1 can be attached to the surface 65 in a simple manner by means of an adhesive tape 7. Due to this, the interface sensor 1 is also suitable for a temporary or mobile use, for example for experiments in a flow channel. In addition, the adhesive tape renders possible a mounting without disturbing the geometry of the surface.

In some embodiments, the interface sensor 1 can contain further elements, in particular mechanical fastening apparatuses which hold the device 31, 32 and 33 for determining the temperatures Tₒ, T_{L} and Tₓ in the intended positions thereof. This can prevent deformation or a change in the distances X2 and X3 and/or reduce the risk of mechanical damage to the interface sensor 1.

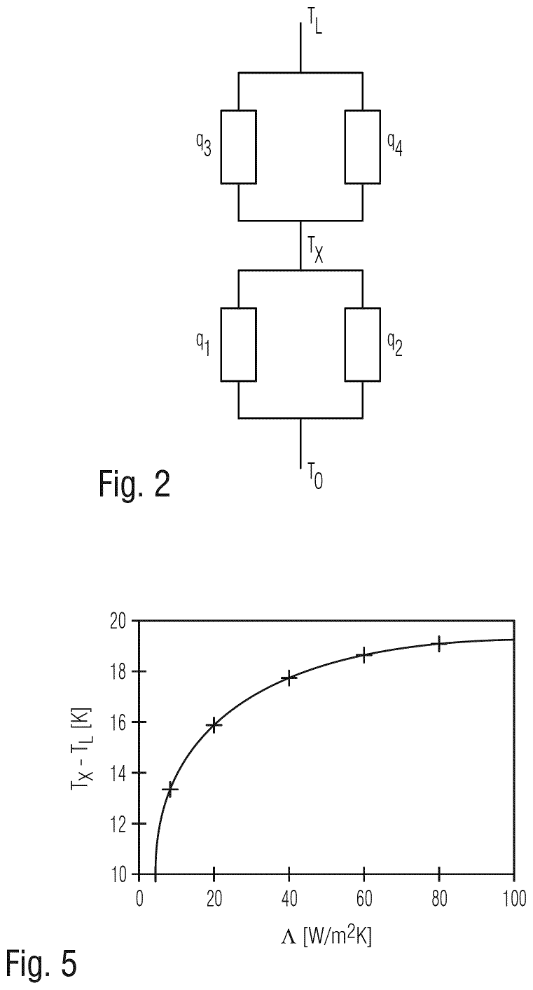

The temperature profile within the interface above the surface 65 follows an exponential function, which is why known methods for evaluating the measured values are essentially based on deriving the coefficients of an exponential function from the measured values Tₒ, Tₓ and T_{L}, which coefficients represent the interface thickness and/or the convective heat transfer coefficient. According to the invention, however, it was realized that the first, third and fourth wires 21, 23 and 24 and optional mechanical support structures or fastening apparatuses are used to derive a heat flow which distorts the measured value Tₓ at the distance X2. As a result, the convective heat transfer coefficients h_{c} determined by means of the interface sensor 1 differ from the convective heat transfer coefficients h_{c} measured without contact by means of laser differential interferometry. Therefore, the invention proposes an alternative evaluation of the first and second thermoelectric voltages in order to obtain a more accurate detection of the interface thickness d and the convective heat transfer coefficient h_{c}. The derivation of the formula according to the invention is explained on the basis of FIG. 2.

FIG. 2 shows a thermal equivalent circuit diagram of the sensor shown in FIG. 1. The first device 31, the second device 32 and the third device 33 for determining the first, second and third temperatures, respectively, are here each designated by the temperature level Tₒ, Tₓ and T_{L} measured by these devices. The amount of heat q2+q4 flows along the sensor 1 due to the convective heat transfer from the surface 65 having the temperature Tₒ into the surrounding half-space having the temperature T_{L}. In this respect, the following applies:

$$q 2 = {h}_{c} \cdot ( {T}_{O} - {T}_{x} )$$

$$q 4 = {h}_{c} \cdot ( {T}_{x} - {T}_{L} )$$

Furthermore, the amount of heat q1+q3 flows from the surface 65 due to the heat transfer along the first wire 21, the third wire 23 and the fourth wire 24 as well as along possibly existing mechanical support structures, which are not shown in FIG. 1. In this respect, the following applies:

$$q 1 = \frac{{λ}_{M}}{X 2} \cdot ( {T}_{O} - {T}_{x} )$$

$$q 3 = \frac{{λ}_{1}}{X 3 - X 2} \cdot ( {T}_{X} - {T}_{L} )$$

As explained in FIG. 2, the heat flows along the sensor can be represented in an electrical equivalent circuit diagram, which is subject to the well-known Kirchhoff's laws of electrical engineering, the respective temperature level corresponding to the electrical voltage and the heat flow density corresponding to the electrical current. Thus, the equivalent circuit diagram shown in FIG. 2 is subject to the first Kirchhoff's law:

$$\text{?} = {q}_{1} + {q}_{2} = {q}_{3} + {q}_{4} .$$

$$\text{?} \text{indicates text missing or illegible when filed}$$

Furthermore, the second Kirchhoff's law applies

$${T}_{O} - {T}_{L} = ( {T}_{O} - {T}_{X} ) + ( {T}_{X} - {T}_{L} ) .$$

The total convective heat flow emanating from the surface 65 (neglecting the radiant heat) corresponds to the temperature difference between the surface 65 and the medium surrounding the surface 65. The following therefore applies:

$${q}_{GES} = ( {T}_{O} - {T}_{L} ) \cdot {h}_{C} = [ ( {T}_{O} - {T}_{X} ) + ( {T}_{X} - {T}_{L} ) ] \cdot {h}_{C} .$$

It follows that q_{GES}=q₂+q₄=q₁+q₂.

Thus, the following applies

$${q}_{4} = {q}_{1} .$$

It follows therefrom that

$$( {T}_{X} - {T}_{L} ) \cdot {h}_{C} = ( {T}_{O} - {T}_{X} ) \cdot \frac{{λ}_{M}}{X 2} .$$

Here, λ_{M} denotes the heat conduction coefficient of the sensor arrangement 1, which results from the geometry and the respectively employed materials. Since X2 is also a constant resulting from the geometry of sensor 1, the convective heat transfer coefficient h_{c} only depends on the constant

$$Λ = \frac{{λ}_{M}}{X 2}$$

and the measured temperature differences. Constant Λ here denotes the heat transmission coefficient of the sensor. Since the temperature differences, as described above, are given directly by the thermoelectric voltages U₁ and U₂, the convective heat transfer coefficient h_{c} and the interface thickness values derived therefrom can be determined simply by forming a difference, multiplication and division. Constant Λ can here be advantageously determined by a calibration measurement. On the one hand, this avoids a time-consuming calculation and, on the other hand, sample scattering from different but nominally identical sensors 1 can be taken into account in a simple manner.

The present relationships shall be explained in more detail below by means of an exemplary embodiment. A surface 65 is considered, which has a surface temperature Tₒ of 20° C. The surface 65 is located in an environment having an air temperature T_{L}=0° C. In addition to the first device 31 for determining a first temperature Tₒ and a third device 33 for determining a third temperature T_{L}, the sensor 1 also has a second device 32 for determining a second temperature Tₓ, which is at a distance X2=2 mm from the surface 65. In the illustrated exemplary embodiment, the measured second temperature Tₓ=17.1° C.

The sensor used according to the invention has a calibration factor Λ=30 W·m⁻²·K⁻¹. When evaluating the measured values Tₒ−T_{L} and Tₓ−T_{L} obtained according to the invention, the convective heat transfer coefficient h_{c} results from the equation

$$\text{?} = \frac{{λ}_{M} \text{?} [ ( {T}_{O} - {T}_{L} ) - ( \text{?} - {T}_{L} ) ]}{X 2 \cdot ( {T}_{x} - {T}_{L} )} .$$

$$\text{?} \text{indicates text missing or illegible when filed}$$

According to the invention, the convective heat transfer coefficient is thus h_{c}=5 W·m⁻²·K⁻¹.

This results in a total heat flux density of 100 W·m⁻². The partial heat flux densities shown in FIG. 2 then amount to

$${q}_{1} = 85.5 W \cdot {m}^{- 2}$$

$${q}_{2} = 14.5 W \cdot {m}^{- 2}$$

$${q}_{3} = 14.5 W \cdot {m}^{- 2}$$

$${q}_{4} = 85.5 W \cdot {m}^{- 2}$$

When evaluating the measured values Tₒ−T_{L} and Tₓ−T_{L} obtained according to the prior art, the convective heat transfer coefficient h_{c} results from the equation

$${h}_{C} = \frac{{λ}_{L} \cdot [ ln ( {T}_{O} - {T}_{L} ) - ln ( {T}_{x} - {T}_{L} ) ]}{X 2} .$$

The value of the convective heat transfer coefficient calculated in this way is h_{c}=2.17 W·m⁻²·K⁻¹. The total heat flow is calculated therefrom as 43.4 W·m⁻². Since the heat flow via the material of the sensor is not taken into account according to the prior art, the amount of the measured value Tₓ of the second device 32 for determining a temperature is systematically overestimated, resulting in a measurement error of approximately 56% in the illustrated exemplary embodiment.

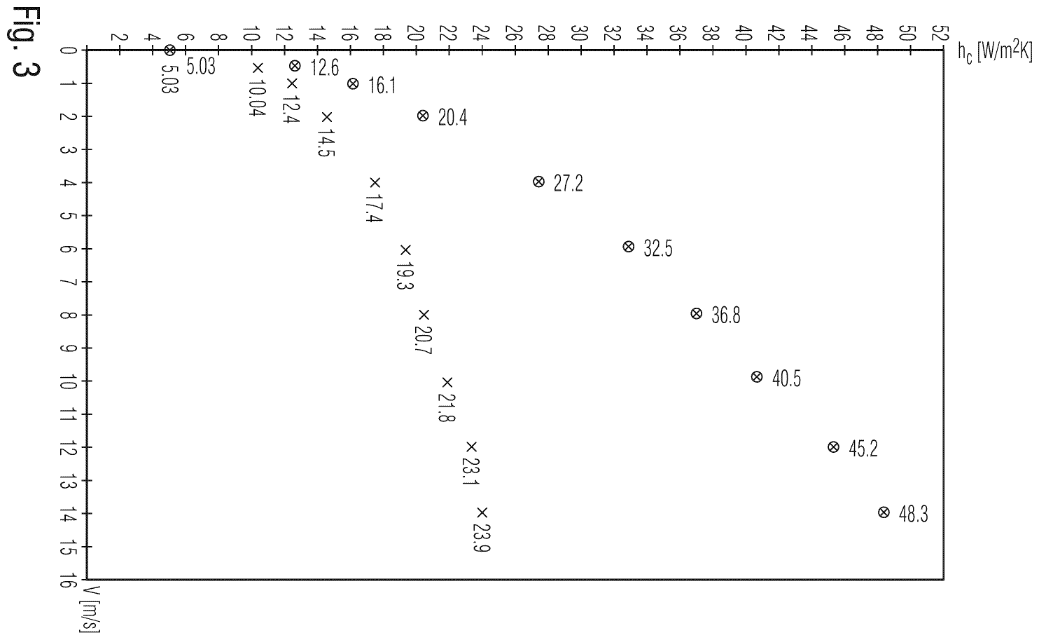

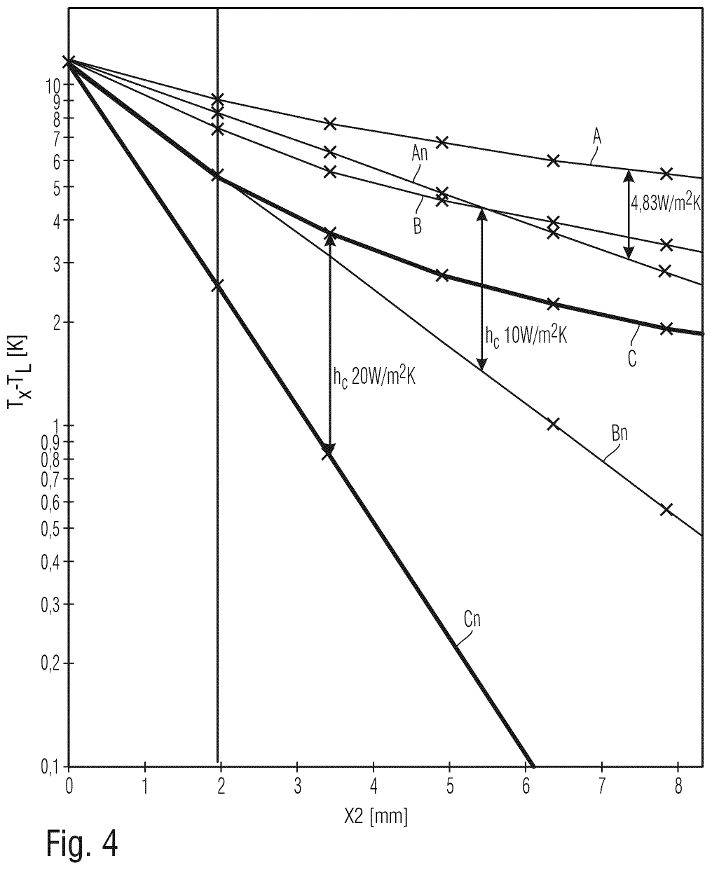

The situation described above in the exemplary embodiment is explained again below on the basis of FIGS. 3 to 4. FIG. 3 here shows the convective heat transfer coefficient h_{c} on the ordinate and the flow velocity v in m·s⁻¹ on the abscissa. The drawing shows the value for the convective heat transfer coefficient h_{c} against the velocity, which is determined in a wind tunnel with a sensor shown in FIG. 1, once when evaluating the measured values according to the known method (x) and once according to the method proposed according to the invention (o). FIG. 3 shows that the amount of the measured value of the convective heat transfer coefficient according to the prior art is systematically underestimated, the measurement error increasing strongly as the flow velocity v increases. According to the invention, it has been possible for the first time to detect the measured value for the convective heat transfer coefficient h_{c} with good accuracy, even for high flow velocities, using a thermal sensor known per se.

FIG. 4 illustrates the influence of the heat flow flowing off or entering via the materials of the sensor 1 on the measured value Tₓ on the basis of the distance X2. Here, the measured value Tₓ−T_{L} in Kelvin is plotted on the ordinate on a logarithmic scale and the distance X2 of the second device 32 for determining the second temperature Tₓ is plotted on the abscissa. A total of six curves are shown, two curves each for three different convective heat transfer coefficients. Here,

| | |
|---|---|
| curve A | shows the expected measured value Tₓ according to the |
| | prior art for h_{c} = 4.83 W · m⁻² · K⁻¹ |
| curve Aₙ | shows the expected measured value Tₓ according to the |
| | invention for h_{c} = 4.83 W · m⁻² · K⁻¹ |
| curve B | shows the expected measured value Tₓ according to the |
| | prior art for h_{c} = 10.0 W · m⁻² · K⁻¹ |
| curve Bₙ | shows the expected measured value Tₓ according to the |
| | invention for h_{c} = 10.0 W · m⁻² · K⁻¹ |
| curve C | shows the expected measured value Tₓ according to the |
| | prior art for h_{c} = 20.0 W · m⁻² · K⁻¹ |
| curve Cₙ | shows the expected measured value Tₓ according to the |
| | invention for h_{c} = 20.0 W · m⁻² · K⁻¹ |

FIG. 4 shows that, in particular in the case of large convective heat transfer coefficients and relatively large sensor geometries, i.e. increasing distance X2, the method according to the invention results in a considerable increase in accuracy.

FIG. 5 shows the dependence of the measured value Tₓ on the basis of the sensor geometry and the materials used for the sensor. The measured value Tₓ−T_{L} in Kelvin is here plotted linearly on the ordinate. The abscissa shows the constant

$$Λ = \frac{{λ}_{M}}{X 2} .$$

The value indicated on the abscissa is thus a measure of the thermal conductivity of the materials of the sensor or the cross-section thereof and of the distance of the second device 32 for determining a temperature Tₓ from the surface 65.

FIG. 5 shows an approximately logarithmic increase in the measured value Tₓ with increasing parameter Λ. In addition, FIG. 5 shows that in particular mechanically robust sensors which have a large heat conduction coefficient λ_{M} due to the large amount of material employed, cause a considerable error in the measurement, which can amount to a factor of 2 or more.

Of course, the invention is not limited to the illustrated embodiments. Therefore, the above description should not be regarded as limiting but as explanatory. The following claims should be understood as meaning that an indicated feature is present in at least one embodiment of the invention. This does not exclude the presence of further features. Insofar as the description or the claims define “first” and “second” features, this designation is used to distinguish between similar features without establishing an order of priority. The research work having led to these results has been funded by the European Union.

What is claimed is:

1. A method for measuring a convective heat transfer coefficient h_{c} on a surface (65) of a body (6) around which flow occurs and/or which is heated, comprising:
with a first device (31), measuring a first temperature (Tₒ) at a first distance X1 from the surface (65);
with a second device (32), measuring a second temperature (Tₓ) at a second distance X2 from the surface (65);
with a third device (33), measuring a third temperature (T_{L}) at a third distance X3 from the surface (65), where X1<X2<X3; and
determining the convective heat transfer coefficient hc from the first, second and third temperatures (To, Tx, TL), the second distance X2 and the heat conduction coefficient λM as follows:
$${h}_{c} = \frac{{λ}_{M} \cdot [ ( {T}_{O} - {T}_{L} ) - ( {T}_{X} - {T}_{L} ) ]}{X 2 \cdot ( {T}_{x} - {T}_{L} )}$$

2. The method according to claim 1, wherein the second distance X2 is 1 mm to 3 mm.

3. The method according to claim 1, wherein the first distance X1 is 0 mm so that the first temperature (Tₒ) corresponds to the temperature of the surface (65).

4. The method according to claim 3, wherein the third distance X3 is sufficiently large so that the third temperature (T_{L}) corresponds to a temperature of the surroundings of the body (6) around which flow occurs.

5. The method according to claim 3, wherein the third distance X3 is between 9 mm and 20 mm.

6. The method according to claim 5, wherein the third distance X3 is between 10 mm and 14 mm.

7. The method according to claim 5, wherein the third distance X3 is between 11 mm and 16 mm.

8. The method according to claim 1, wherein:
the first device (31), the second device (32) and the third device (33) comprise thermocouples;
a first thermoelectric voltage U₁ is measured between the first device (31) and the third device (33); and
a second thermoelectric voltage U₂ IS measured between the second device (32) and the third device (33).

9. The method according to claim 1, wherein a parameter
$$Λ = \frac{{λ}_{M}}{X 2}$$
is determined by a calibration measurement.

10. The method according to claim 9, wherein the calibration measurement is carried out by laser differential interferometry.

11. A method for measuring the thickness d of an interface above a surface (65) of a body (6) around which flow occurs and/or which is heated, comprising:
with a first device (31), measuring a first temperature (Tₒ) at a first distance X1 from the surface (65);
with a second device (32), measuring a second temperature (Tₓ) at a second distance X2 from the surface (65);
with a third device (33), measuring a third temperature (T_{L}) at a third distance X3 from the surface (65), where X1<X2<X3; and
determining the thickness d of the interface is determined from the first, second and third temperatures (To, Tx, TL) and the distance X2 as follows:
$$d = \frac{{λ}_{L} \cdot X 2 \cdot ( {T}_{x} - {T}_{L} )}{{λ}_{M} \cdot [ ( {T}_{O} - {T}_{L} ) - ( {T}_{X} - {T}_{L} ) ]}$$
where:
λ_{L} denotes the heat conduction coefficient of a medium flowing around the surface (65); and
λ_{M} denotes the heat conduction coefficient of the first, second and third devices.

12. The method according to claim 11, wherein the second distance X2 is 1 mm to 3 mm.

13. The method according to claim 11, wherein the first distance X1 is 0 mm so that the first temperature (Tₒ) corresponds to the temperature of the surface (65).

14. The method according to claim 13, wherein the third distance X3 is sufficiently large so that the third temperature (T_{L}) corresponds to a temperature of the surroundings of the body (6) around which flow occurs.

15. The method according to claim 13, wherein the third distance X3 is between 9 mm and 20 mm.

16. The method according to claim 15, wherein the third distance X3 is between 10 mm and 14 mm.

17. The method according to claim 15, wherein the third distance X3 is between 11 mm and 16 mm.

18. The method according to claim 11, wherein:
the first device (31), the second device (32) and the third device (33) comprise thermocouples;
a first thermoelectric voltage U₁ is measured between the first device (31) and the third device (33); and
a second thermoelectric voltage U₂ IS measured between the second device (32) and the third device (33).

19. The method according to claim 11, wherein a parameter
$$Λ = \frac{{λ}_{M}}{X 2}$$
is determined by a calibration measurement.

20. The method according to claim 19, wherein the calibration measurement is carried out by laser differential interferometry
